(19) United States
(12) Patent Application Publication
(10) Pub. No.: US 2026/0148568 A1
(43) Pub. Date: May 28, 2026

(54) METHOD AND APPARATUS FOR DETERMINING DRIVABLE AREA, STORAGE MEDIUM, TERMINAL, AND COMPUTER PROGRAM PRODUCT

(71) Applicant: Black Sesame Technologies Co., Ltd., Wuhan (CN)

(72) Inventor: Chenglong Yi, Shanghai (CN)

(73) Assignee: Black Sesame Technologies Co., Ltd., Wuhan (CN)

(21) Appl. No.: 19/396,075

(22) Filed: Nov. 20, 2025

(30) Foreign Application Priority Data
Nov. 22, 2024 (CN) 202411692042.6

(51) Int. Cl. G06V 20/58; G06V 10/26; G06V 10/44; G06V 10/75; G06V 10/80; G06V 10/82

(52) U.S. Cl. CPC G06V 20/58; G06V 10/26; G06V 10/44; G06V 10/751; G06V 10/806; G06V 10/82

(57) ABSTRACT

A method and apparatus for determining a drivable area, a storage medium, a terminal and a computer program product are provided. The method includes: performing drivable area segmentation on an input image to obtain a plurality of first boundary points; performing drivable area segmentation on a target image area to obtain a plurality of second boundary points, where the target image area is a portion of the input image; matching the plurality of first boundary points with the plurality of second boundary points to obtain successfully matched boundary point pairs; and replacing the successfully matched first boundary points among the plurality of first boundary points with matched second boundary points, and taking an area formed by the replaced first boundary points and at least a portion of the unsuccessfully matched first boundary points as a target drivable area.

### RELATED APPLICATION

This application claims the benefit under 35 U.S.C. § 119(a) of the filing date of Chinese Patent Application No. 202411692042.6, filed in the Chinese Patent Office on Nov. 22, 2024. The disclosure of the foregoing application is herein incorporated by reference in its entirety.

### TECHNICAL FIELD

The present disclosure relates to an autonomous driving technology field, and more particularly, to a method and apparatus for determining a drivable area, a storage medium, a terminal, and a computer program product.

### BACKGROUND

With the rapid development of autonomous driving technology, ensuring safe and reliable autonomous driving is becoming increasingly vital. A primary aspect of achieving safety is environmental awareness, making accurate detection of drivable areas crucial. Detecting drivable areas not only determines which areas are drivable and which are not, but also affects subsequent path planning and decision-making, assisting in intelligent and safe driving control.

Due to diverse shapes of drivable areas, existing solutions typically segment an input image to determine a drivable area. However, a 2D pixel-level drivable area is prone to blurring at a boundary of the drivable area, and a positional error resulted from a pixel-level error increases as a distance between the boundary and a camera becomes longer.

Therefore, there is an urgent need to provide a method for determining a drivable area that can effectively reduce an error in a distant boundary of the drivable area obtained based on image segmentation.

### SUMMARY

Embodiments of the present disclosure may reduce an error in a distant boundary of a drivable area obtained based on image segmentation, and mitigate a fuzzy boundary problem of the drivable area.

In an embodiment of the present disclosure, a method for determining a drivable area is provided, including: performing drivable area segmentation on an input image to obtain a plurality of first boundary points; performing drivable area segmentation on a target image area to obtain a plurality of second boundary points, where the target image area is a portion of the input image; matching the plurality of first boundary points with the plurality of second boundary points to obtain successfully matched boundary point pairs; and replacing the successfully matched first boundary points among the plurality of first boundary points with matched second boundary points, and taking an area formed by the replaced first boundary points and at least a portion of the unsuccessfully matched first boundary points as a target drivable area.

Optionally, the target image area is a preset area around a center point of the input image, or a preset area around a vanishing point of the drivable area in the input image.

Optionally, said matching the plurality of first boundary points with the plurality of second boundary points to obtain the successfully matched boundary point pairs includes: filtering the plurality of first boundary points and the plurality of second boundary points respectively to obtain filtered first boundary points and filtered second boundary points; pairing the filtered first boundary points and the filtered second boundary points to obtain a plurality of pairs of candidate boundary points; generating a cost matrix using Euclidean distances corresponding to the plurality of pairs of candidate boundary points, where a plurality of elements in the cost matrix are in one-to-one correspondence with the plurality of pairs of candidate boundary points, and an element value of each element is a Euclidean distance between two candidate boundary points in the corresponding pair of candidate boundary points; and determining the successfully matched boundary point pairs among the plurality of pairs of candidate boundary points based on the cost matrix.

Optionally, one or more of the following are met: the filtered first boundary points being first boundary points located in the target image area among the plurality of first boundary points; or the filtered second boundary points being boundary points remaining after removing target boundary points from the plurality of second boundary points, where the target boundary points are points on a first edge of the drivable area formed by the plurality of second boundary points.

Optionally, the cost matrix is a two-dimensional matrix including M rows of elements, where M is a positive integer; said determining the successfully matched boundary point pairs among the plurality of pairs of candidate boundary points based on the cost matrix includes: for each row of the cost matrix, subtracting a minimum element of the row from each element of the row, and for each column of the cost matrix, subtracting a minimum element of the column from each element of the column, thereby obtaining a preliminary update matrix; performing one or more rounds of iterative operations based on the preliminary update matrix to obtain a target cost matrix, where in each round of iteration, a minimum number of horizontal lines and vertical lines are used to cover all elements whose element values in the update matrix of the current round are a first value, and if a sum of the number of the horizontal lines and the vertical lines is less than M, a minimum first element is subtracted from each first element in the update matrix of the current round that is not covered by the horizontal lines or the vertical lines, and the minimum first element is added to each second element that is covered by both the horizontal lines and the vertical lines to obtain the update matrix of a next round, a next round of iteration is continued until the sum of the number of the horizontal lines and the vertical lines is equal to M, and the update matrix of the last round is used as the target cost matrix, where the update matrix of the first round is the preliminary update matrix; and taking the candidate boundary point pairs corresponding to the elements with the first value in the target cost matrix as the successfully matched boundary point pairs.

Optionally, the drivable area segmentation on the input image includes boundary feature acquisition and post-processing; where a boundary feature of the drivable area is determined via the boundary feature acquisition based on the input image; and the post-processing includes: performing pixel value conversion on the boundary feature of the drivable area to obtain a converted image; performing contour extraction on the converted image to obtain a plurality of candidate connected areas; taking boundary points of the candidate connected area with a largest area among the plurality of candidate connected areas as preliminary boundary points; and performing linear transformation on coordinates of the preliminary boundary points to obtain the plurality of first boundary points.

Optionally, said performing contour extraction on the converted image to obtain the plurality of candidate connected areas includes: performing binarization processing on the converted image to obtain a grayscale image; performing an opening operation on the grayscale image to obtain a denoised image; and performing contour extraction on the denoised image to obtain the plurality of candidate connected areas.

Optionally, the boundary feature acquisition includes: performing a plurality of feature extraction operations at different scales on the input image to obtain a plurality of image features, where input data of the first feature extraction operation is the input image, and from the second feature extraction operation, input data of the current feature extraction operation is output data of a previous feature extraction operation; performing a plurality of feature fusion operations at different scales based on the plurality of image features to obtain a fusion feature, where the plurality of feature extraction operations are in one-to-one correspondence with the plurality of feature fusion operations, input data of the first feature fusion operation is image features output by the last feature extraction operation, and from the second feature fusion operation, input data of the current feature fusion operation includes output data of the corresponding feature extraction operation and output data of a previous feature fusion operation; and selecting a target image feature from the plurality of image features, performing feature splicing on the target image feature and the fusion feature to obtain a splicing feature, and decoding the splicing feature to obtain the boundary feature of the drivable area.

Optionally, the boundary feature acquisition performed on the input image is implemented using a pre-trained model which includes a feature extraction network, a feature fusion network, and a feature prediction network; where the feature extraction network performs the plurality of feature extraction operations at different scales on the input image to obtain the plurality of image features; the feature fusion network performs the plurality of feature fusion operations at different scales based on the plurality of image features to obtain the fusion feature; and the feature prediction network performs the feature splicing on the target image feature and the fusion feature among the plurality of image features to obtain the splicing feature, and decodes the splicing feature to obtain the boundary feature of the drivable area.

Optionally, the pre-trained model is trained in a following manner: determining an initial model, where the initial model includes a to-be-trained feature extraction network, a to-be-trained feature fusion network, a to-be-trained feature prediction network, and a to-be-trained auxiliary network; inputting sample images into the initial model for initial training based on a preset first target loss function to obtain an optimized feature extraction network, an optimized feature fusion network, an optimized feature prediction network, and an optimized auxiliary network; fixing parameters of the optimized feature extraction network and the optimized feature fusion network, and inputting the sample images into the initial model for retraining based on a preset second target loss function to obtain a fine-tuned feature prediction network and a fine-tuned auxiliary network; and constructing the pre-trained model by using the optimized feature extraction network, the optimized feature fusion network, and the fine-tuned feature prediction network; where an auxiliary boundary feature is determined by the fine-tuned auxiliary network based on output data of the plurality of feature fusion operations in the feature fusion network.

Optionally, the first target loss function and the second target loss function are obtained by performing a weighted operation based on at least a first sub-loss function and a second sub-loss function; and during a training process, a function value of the first sub-loss function is determined based on a difference between a plurality of predicted boundary points and a plurality of labeled boundary points, and a function value of the second sub-loss function is determined based on a difference between a plurality of auxiliary predicted boundary points and the plurality of labeled boundary points; where the plurality of predicted boundary points are obtained by performing post-processing on a sample boundary feature output by the feature prediction network, the plurality of auxiliary predicted boundary points are obtained by performing post-processing on the auxiliary boundary feature output by the fine-tuned auxiliary network, and the plurality of labeled boundary points are boundary points of the drivable area labeled on the sample images.

Optionally, a weight of the first sub-loss function is greater than a weight of the second sub-loss function.

In an embodiment of the present disclosure, an apparatus for determining a drivable area is provided, including: a first segmentation circuitry configured to perform drivable area segmentation on an input image to obtain a plurality of first boundary points; a second segmentation circuitry configured to perform drivable area segmentation on a target image area to obtain a plurality of second boundary points, where the target image area is a portion of the input image; a matching circuitry configured to match the plurality of first boundary points with the plurality of second boundary points to obtain successfully matched boundary point pairs; and a target drivable area determination circuitry configured to: replace the successfully matched first boundary points among the plurality of first boundary points with matched second boundary points, and take an area formed by the replaced first boundary points and at least a portion of the unsuccessfully matched first boundary points as a target drivable area.

In an embodiment of the present disclosure, a storage medium having a computer program stored thereon is provided, where when the computer program is run by a processor, the above method is performed.

In an embodiment of the present disclosure, a terminal including a memory and a processor is provided, where the memory stores a computer program that can be run on the processor, and the processor performs the above method when running the computer program.

In an embodiment of the present disclosure, a computer program product including a computer program is provided, where when the computer program is run by a processor, the above method is performed.

Embodiments of the present disclosure may provide following advantages.

In embodiments of the present disclosure, as the target image area is a portion of the input image and has a smaller original size than that of the input image, when both original sizes are scaled to meet a same input size, the size of the boundary of the drivable area in the target image area, particularly a size of the boundary of the drivable area located farther from a camera in an image, is larger than the size of the boundary of the drivable area in the input image. Accordingly, after the drivable area segmentation, positions of the plurality of second boundary points obtained are usually more accurate than those of the plurality of first boundary points. Therefore, by matching the plurality of first boundary points with the plurality of second boundary points, the second boundary points that best match the first boundary points are found. The successfully matched second boundary points are used to replace the matched first boundary points. The target drivable area is obtained based on the replaced first boundary points and at least a portion of the unsuccessfully matched first boundary points. Compared with using the area formed by the plurality of first boundary points as the target drivable area, the embodiments may effectively improve definition and accuracy of the obtained target drivable area, more particularly mitigating a blurring problem at the boundary of the drivable area located farther from the camera.

Further, in existing techniques, after the boundary feature of the drivable area of the input image is obtained, an upsampling scheme based on a complex network structure is typically used to determine the plurality of first boundary points. For example, a deconvolution operation is performed through a deconvolution network to restore a size of the boundary feature of the drivable area to the size of the input image and provide a classification result for corresponding pixels to obtain the plurality of first boundary points. However, when the network performs inference in hardware, an inference process of an operator corresponding to the upsampling is relatively time-consuming, making it difficult to meet real-time requirements of autonomous driving.

Further, after determining the boundary feature of the drivable area based on the input image, embodiments of the present disclosure use a post-processing solution based on image contour extraction and coordinate linear transformation to obtain the plurality of first boundary points. Specifically, the boundary feature of the drivable area is first converted into image data, and contour extraction and filtering are performed at an image level to determine the plurality of preliminary boundary points that form the drivable area. Afterward, a coordinate linear transformation is performed to obtain the plurality of first boundary points. Therefore, compared with the existing techniques of obtaining the plurality of first boundary points through upsampling based on the complex network, the embodiments may significantly reduce time consumption of post-processing, improve efficiency of drivable area segmentation, meet the real-time requirements of autonomous driving, and have lower requirements for computing resources.

Further, linearly transforming the size of the boundary feature of the drivable area to the size of the input image generally results in aliasing of the boundary of the drivable area. Further, as the converted image obtained by pixel value conversion may include noises, directly performing contour extraction on the converted image generally results in appearance of outliers, resulting in creation of a plurality of closed polygons. Therefore, in the embodiments of the present disclosure, after pixel value conversion is performed to obtain the converted image, binarization processing and an opening operation are sequentially performed to effectively remove noises and edge outliers, improve smoothness, and reduce contour aliasing caused by subsequent linear transformation of coordinate points, thereby obtaining more accurate and effective boundary points of the drivable area.

Further, in the existing techniques, a complex auxiliary network is used as a feature prediction network to obtain the boundary feature of the drivable area of the input image. This solution consumes more resources during model deployment and a reasoning process. In comparison, in the embodiments of the present disclosure, the pre-trained model for determining the boundary feature of the drivable area does not include a complex auxiliary network during a reasoning stage. Instead, the auxiliary network is only used to assist model training and parameter optimization in a model training stage. In a model reasoning stage, the embodiments of the present disclosure use a more lightweight and streamlined feature prediction network to predict the boundary feature of the drivable area. In this manner, on the basis of obtaining sufficiently optimized network parameters, computing resources and time overhead of model deployment and reasoning may be effectively reduced.

### BRIEF DESCRIPTION OF THE DRAWINGS

This present application is submitted with colored drawings. In accordance with 37 C.F.R. § 1.84(a)(2), a petition is submitted to request acceptance of the colored drawings as the only practical medium by which aspects of the subject matter sought to be patented in this application may be accurately conveyed. The patent or application file contains at least one drawing executed in color. Copies of this patent or patent application publication with color drawing(s) will be provided by the Office upon request and payment of the necessary fee.

FIG. 1 is a flow chart of a method for determining a drivable area, according to an embodiment of the present disclosure

FIG. 2 is a partial flow chart of a specific implementation of S11 in FIG. 1, according to an embodiment of the present disclosure.

FIG. 3 is a comparison diagram of effects of directly performing contour extraction on a converted image, and performing contour extraction on the converted image which has been subjected to binarization and an opening operation, according to an embodiment of the present disclosure.

FIG. 4 is a partial flow chart of another specific implementation of S11 in FIG. 1, according to an embodiment of the present disclosure.

FIG. 5 is a partial schematic structural diagram of an initial model that is used for training to obtain a pre-trained model according to an embodiment of the present disclosure.

FIG. 6 is a flow chart of a training method for training the initial model shown in FIG. 5 to obtain the pre-trained model according to an embodiment of the present disclosure.

FIG. 7 is a flow chart of a specific implementation of S13 in FIG. 1, according to an embodiment of the present disclosure.

FIG. 8 is a comparison diagram of effects of a target drivable area obtained by performing drivable area segmentation on an input image and a target drivable area obtained by using a solution in an embodiment of the present disclosure.

FIG. 9 is a schematic structural diagram of an apparatus for determining a drivable area according to an embodiment of the present disclosure.

### DETAILED DESCRIPTION

In order to clarify the objects, characteristics and advantages of the disclosure, embodiments of present disclosure will be described in detail in conjunction with accompanying drawings.

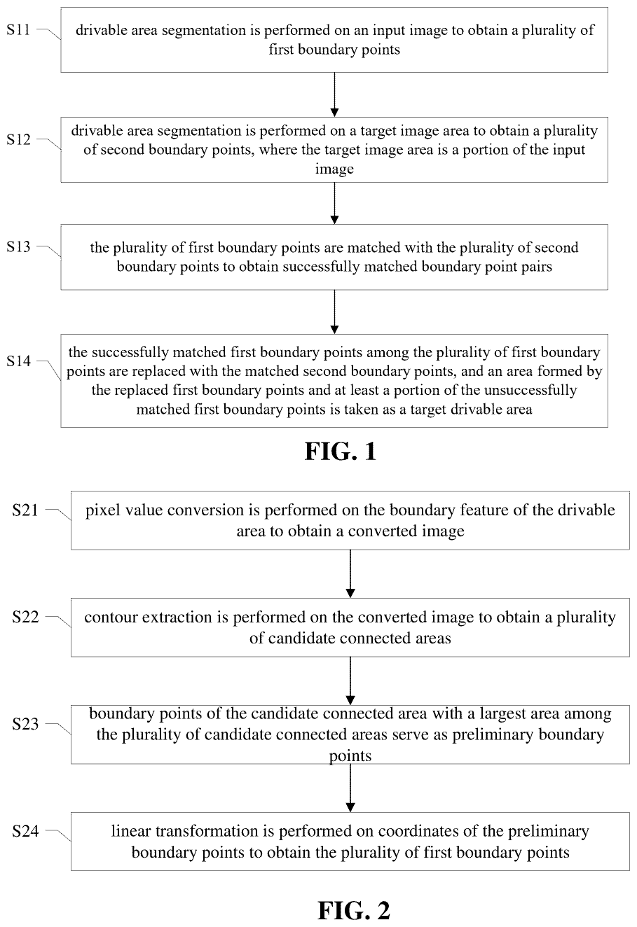

Referring to FIG. 1, FIG. 1 is a flow chart of a method for determining a drivable area according to an embodiment of the present disclosure. The method may be applied to terminal devices with an image processing function, such as, but not limited to, computers, mobile phones, tablet computers, smart wearable devices (such as smart watches, smart headsets, or laptops), onboard terminals of autonomous vehicles, servers, cloud platforms, and distributed computing environment including any of the above.

The method for determining the drivable area may include S11 to S14.

In S11, drivable area segmentation is performed on an input image to obtain a plurality of first boundary points.

In S12, drivable area segmentation is performed on a target image area to obtain a plurality of second boundary points, where the target image area is a portion of the input image.

In S13, the plurality of first boundary points are matched with the plurality of second boundary points to obtain successfully matched boundary point pairs.

In S14, the successfully matched first boundary points among the plurality of first boundary points are replaced with the matched second boundary points, and an area formed by the replaced first boundary points and at least a portion of the unsuccessfully matched first boundary points is taken as a target drivable area.

In a specific implementation of S11, the input image may be an image of a scene captured during vehicle driving, for example, an image of a scene within a predetermined area in front of an autonomous vehicle. The input image may include the drivable area (e.g., a road area). It is understood that in most autonomous driving scenarios, a direction in which the drivable area extends is close to an orientation of a camera lens (also known as a shooting direction). In other words, an angle between the direction in which the drivable area extends and the orientation of the camera lens is typically within an angular range of [0°, 90°).

In a specific implementation of S12, the target image area is a portion of the input image.

The plurality of first boundary points may specifically refer to a plurality of sampling boundary points that form a contour (or a boundary line) of the drivable area (e.g., a road area) in the input image. The plurality of second boundary points may specifically refer to a plurality of sampling boundary points that form a contour of the drivable area in the target image area.

Specifically, the target image area may be determined in at least any of the following manners.

In a first approach, a preset area around a center point of the input image (e.g., a rectangular area or other regular/irregular area centered on the center point of the input image) serves as the target image area.

In a second approach, a preset area around a vanishing point of the drivable area in the input image (e.g., a rectangular area or other regular/irregular area centered on the vanishing point of the drivable area in the input image) serves as the target image area.

A method for determining the vanishing point of the drivable area in the input image includes following steps. First, the drivable area in the input image is determined using a method such as segmentation or target recognition. Afterward, one of pixels within the drivable area (including the boundary of the drivable area) whose depth values are greater than a preset depth value threshold may be selected as the vanishing point. Alternatively, a pixel corresponding to an average of coordinates of the pixels whose depth values are greater than the preset depth value threshold may serve as the vanishing point. Alternatively, other appropriate methods may be used to determine the vanishing point.

In a third approach, average area division is performed on the input image, and one or more appropriate areas are selected as the target image area. For example, the input image is evenly divided into six rectangular or square subareas, and then the subarea located at a center of an upper edge of the input image and/or the subarea located at a center of a lower edge of the input image may be selected as the target image area.

In a specific implementation, an execution order of S11 and S12 may be interchanged, or S11 and S12 are executed simultaneously. During drivable area segmentation on the input image and the target image area, input sizes of the input image and the target image area are consistent, and drivable area segmentation methods used may also be completely consistent.

More specifically, the drivable area segmentation on the input image and the target image area may include feature extraction (e.g., implemented by a feature extraction network). The plurality of first boundary points may be determined based on feature data obtained by the feature extraction on the input image, and the plurality of second boundary points may be determined based on feature data obtained by the feature extraction on the target image area. The input size and a feature extraction scale (also referred to as “downsampling rate”) for the feature extraction of the input image are consistent with the input size and a feature extraction scale for the feature extraction of the target image area.

In a specific implementation, before the feature extraction is performed, the input image and the target image area may be scaled to input sizes suitable for the feature extraction network. For example, if an original size of the input image is 2560 1440, an original size of the target image area is 640 360, and an input size of the feature extraction network is 1280 720, the input image needs to be reduced in size (e.g., downsampling) to obtain the input size of the feature extraction network, and the target image area needs to be enlarged in size (e.g., upsampling) to obtain the input size of the feature extraction network.

In specific implementations, the feature extraction may be performed on the original image after removing invalid edge areas (e.g., a sky area at an upper edge of the image, and a vehicle front area at a lower edge of the image). To further improve segmentation efficiency and reduce overhead, after scaling to the input size suitable for the feature extraction network, operations such as mean subtraction, variance division, and conversion to a preset format may be performed on the input image and target image areas.

Understandably, small objects occupy a relatively small area in the input image, making their feature information difficult to fully extract. Due to the limited size, feature extraction (typically downsampling using a convolutional neural network) may result in complete loss of features (for example, when a small object is 15×15 pixels in size and the feature extraction scale is 1/16, features obtained by feature extraction on the small object are barely represented in the image) of the small objects. The boundary of the drivable area obtained by segmentation, especially those farther from the camera in the image, are smaller in size due to being pixel-level. Therefore, the feature extraction may result in missed or incorrect boundary detection.

Further, during the feature extraction, if the input size of the target image area is consistent with the input size of the input image, an area occupied by the boundary of the drivable area in the target image area, especially the boundary farther from the camera in the image, is larger than an area occupied by the boundary of the drivable area in the input image. After being subjected to feature extraction at a same scale, the target image area can provide richer boundary feature information than the input image. In other words, the positions of the plurality of second boundary points are more accurate than those of the plurality of first boundary points.

Referring to FIG. 2, FIG. 2 is a partial flow chart of a specific implementation of S11 in FIG. 1. In this implementation, the drivable area segmentation on the input image in S11 may specifically include boundary feature acquisition and post-processing. A boundary feature of the drivable area is determined via the boundary feature acquisition based on the input image. The post-processing may include following S21 to S24.

In S21, pixel value conversion is performed on the boundary feature of the drivable area to obtain a converted image.

For example, the boundary feature of the drivable area may be a feature matrix of n×c×h×w, and the converted image may be a matrix of n×3×h×w, where c represents a number of channels or dimensions of the boundary feature of the drivable area, ‘3’ represents a number of channels of pixels of the converted image, h represents a number of rows of the matrix (corresponding to height of the converted image), w represents a number of columns of the matrix (corresponding to width of the converted image), and n represents a batch size, i.e., a number of images processed in the same batch.

In S22, contour extraction is performed on the converted image to obtain a plurality of candidate connected areas.

Further, S22 includes: performing binarization processing on the converted image to obtain a grayscale image; performing an opening operation on the grayscale image to obtain a denoised image; and performing contour extraction on the denoised image to obtain the plurality of candidate connected areas.

The opening operation may remove noise data, boundary abnormal values, etc. in the grayscale image, and may also achieve boundary smoothing to a certain extent.

In S23, boundary points of the candidate connected area with a largest area among the plurality of candidate connected areas serve as preliminary boundary points.

In S24, linear transformation is performed on coordinates of the preliminary boundary points to obtain the plurality of first boundary points.

A factor of the linear transformation is a ratio of the input image size (specifically, the input size of the input image when being fed into the feature extraction network) to a size of the boundary feature of the drivable area. For example, if the size of the input image is 1280 720 and the size of the boundary feature of the drivable area is 320 180, the factor of the linear transformation is 4.

It should be noted that in existing techniques, after the boundary feature of the drivable area of the input image is obtained, an upsampling scheme based on a complex network structure is typically used to determine the plurality of first boundary points. For example, a deconvolution operation is performed through a deconvolution network to restore a size of the boundary feature of the drivable area to the size of the input image and provide a classification result for corresponding pixels to obtain the plurality of first boundary points. However, when the network performs inference in hardware, an inference process of an operator corresponding to the upsampling is relatively time-consuming, making it difficult to meet real-time requirements of autonomous driving.

In comparison, the embodiments of the present disclosure use an image-based contour extraction and coordinate linear transformation scheme to replace the above-mentioned network-based upsampling scheme. That is, the boundary feature of the drivable area is first converted into image data, and contour extraction and filtering are performed at an image level to determine the plurality of preliminary boundary points that form the drivable area. Afterward, a coordinate linear transformation is performed to obtain the plurality of first boundary points. The coordinate linear transformation can restore coordinate values of each preliminary boundary point to coordinate values corresponding to the size of the input image, so that the size of the drivable area formed by the plurality of first boundary points is consistent with the size of the input image. Therefore, the embodiments may significantly reduce time consumption of post-processing, improve efficiency of drivable area segmentation, meet the real-time requirements of autonomous driving, and have lower requirements for computing resources.

Further, in embodiments of the present disclosure, when performing the linear coordinate transformation to restore the coordinate values of each preliminary boundary point to the coordinate values corresponding to the size of the input image, aliasing issues often occur on the boundary of the drivable area. Further, as the converted image obtained by pixel value conversion may include noises, directly performing contour extraction on the converted image generally results in appearance of outliers, resulting in creation of a plurality of closed polygons. Therefore, in the embodiments of the present disclosure, after pixel value conversion is performed to obtain the converted image, binarization processing and an opening operation are sequentially performed to effectively remove noises and edge outliers, improve smoothness, and reduce contour aliasing caused by subsequent linear transformation of coordinate points, thereby obtaining more accurate and effective boundary points of the drivable area.

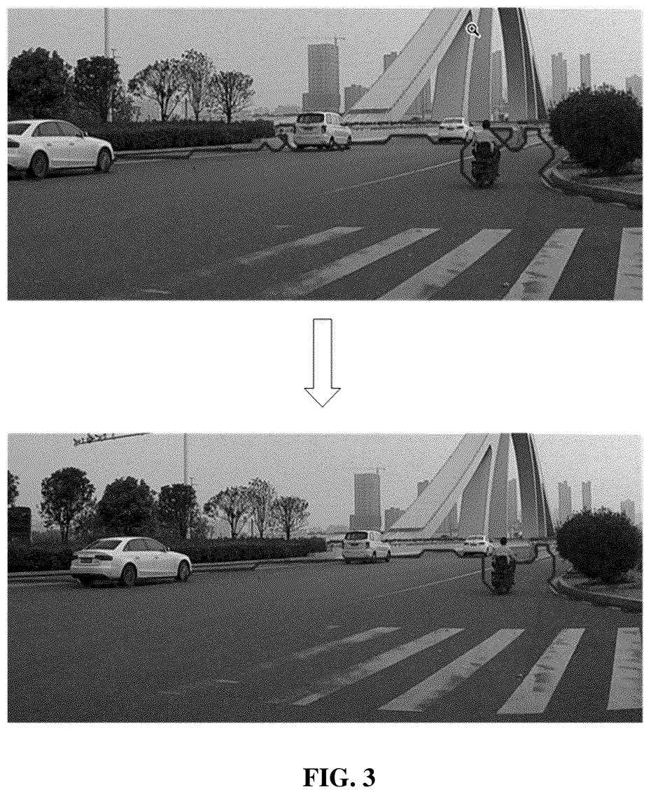

Referring to FIG. 3, FIG. 3 is a comparison diagram of effects of directly performing contour extraction on a converted image, and performing contour extraction on the converted image which has been subjected to binarization and an opening operation.

Specifically, a blue boundary line shown in an upper part of FIG. 3 is the contour of the drivable area obtained by directly performing contour extraction on the converted image (i.e., the image obtained by performing pixel value conversion on the boundary feature of the drivable area). A blue boundary line shown in a lower part of FIG. 3 is the contour of the drivable area obtained by performing contour extraction on the denoised image, where the denoised image is obtained by performing binarization and the opening operation on the converted image in sequence.

By comparison, it can be seen that a contour of the drivable area in the upper part of FIG. 3 has aliasing problems and poor smoothness, while the aliasing problems of the contour of the drivable area in the lower part of FIG. 3 are mitigated, and the smoothness and definition are significantly improved.

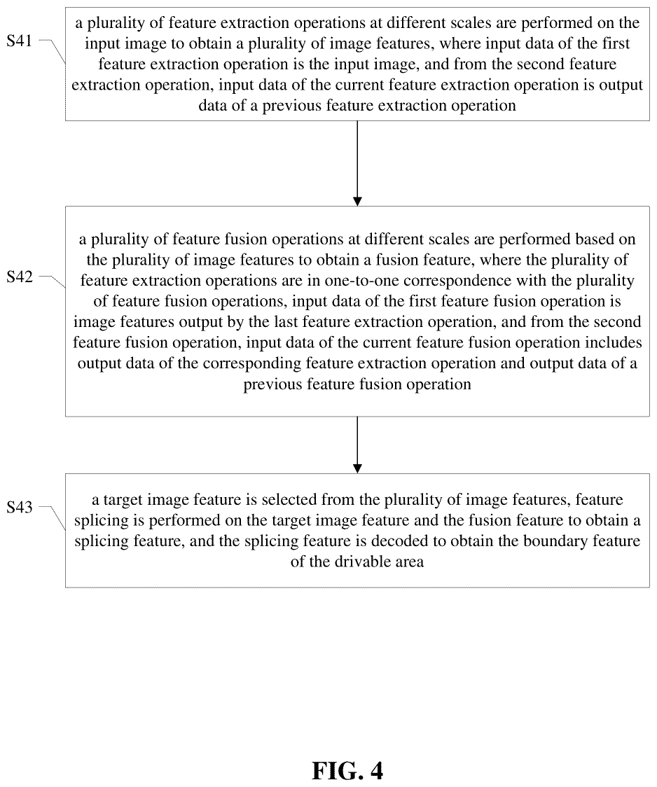

Refer to FIG. 4, FIG. 4 is a partial flow chart of another specific implementation of S11 in FIG. 1. In this implementation, the drivable area segmentation on the input image in S11 may specifically include boundary feature acquisition and post-processing. The boundary feature acquisition may include following S41 to S43.

In S41, a plurality of feature extraction operations at different scales are performed on the input image to obtain a plurality of image features, where input data of the first feature extraction operation is the input image, and from the second feature extraction operation, input data of the current feature extraction operation is output data of a previous feature extraction operation.

From the first feature extraction operation, the scale of feature extraction decreases successively. In a non-limiting manner, five feature extraction operations at different scales may be performed on the input image, with the scales of the first to fifth feature extractions being ¼, ⅛, 1/16, 1/32, and 1/64, respectively.

In S42, a plurality of feature fusion operations at different scales are performed based on the plurality of image features to obtain a fusion feature, where the plurality of feature extraction operations are in one-to-one correspondence with the plurality of feature fusion operations, input data of the first feature fusion operation is image features output by the last feature extraction operation, and from the second feature fusion operation, input data of the current feature fusion operation includes output data of the corresponding feature extraction operation and output data of a previous feature fusion operation.

From the first feature fusion operation, the scale of feature fusion increases successively. Further, the extraction scale of each feature extraction operation is consistent with the fusion scale of the corresponding feature fusion operation. In a non-limiting manner, five feature fusion operations at different scales may be performed, with the scales of the first to fifth feature fusion operations being 1/64, 1/32, 1/16, ⅛, and ¼, respectively.

In S43, a target image feature is selected from the plurality of image features, feature splicing is performed on the target image feature and the fusion feature to obtain a splicing feature, and the splicing feature is decoded to obtain the boundary feature of the drivable area.

In a specific implementation, the target image feature selected may be the image feature obtained by the first feature extraction operation (for example, the image feature obtained by performing the feature extraction operation at a scale of ¼ on the input image). A size of the target image feature and a size of the fusion feature are consistent.

Further, before the feature splicing is performed on the target image feature and the fusion feature, a Convolutional Neural Network (CNN) may be used to perform a convolution operation on the target image feature and/or the fusion feature to obtain richer and more accurate feature information.

In a specific implementation, in S11 shown in FIG. 1, the boundary feature acquisition performed on the input image is implemented using a pre-trained model which includes a feature extraction network, a feature fusion network, and a feature prediction network. The feature extraction network performs the plurality of feature extraction operations at different scales on the input image to obtain the plurality of image features; the feature fusion network performs the plurality of feature fusion operations at different scales based on the plurality of image features to obtain the fusion feature; and the feature prediction network performs the feature splicing on the target image feature and the fusion feature among the plurality of image features to obtain the splicing feature, and decodes the splicing feature to obtain the boundary feature of the drivable area.

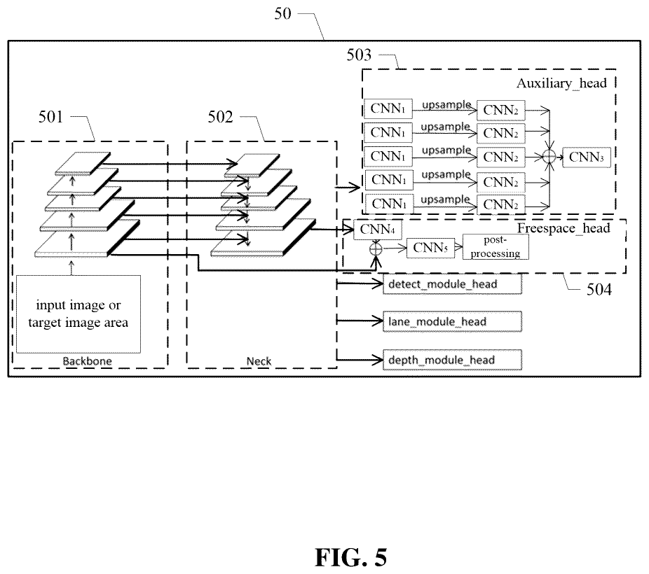

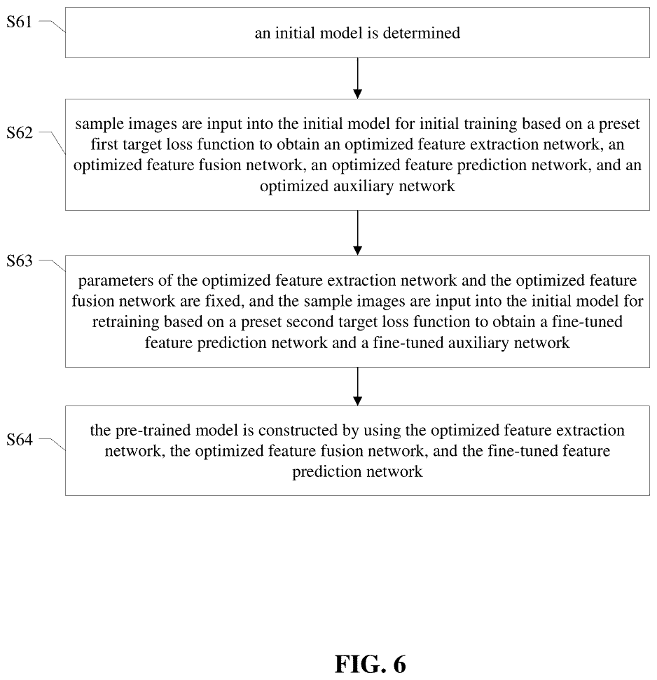

Hereafter, an initial model used to obtain the pre-trained model, and related principles and a training method of the initial model in an embodiment of the present disclosure are described in detail in conjunction with FIGS. 5 and 6.

FIG. 5 is a partial schematic structural diagram of an initial model that is used for training to obtain a pre-trained model according to an embodiment of the present disclosure, and FIG. 6 is a flow chart of a training method for training the initial model shown in FIG. 5 to obtain the pre-trained model.

The training method may specifically include following S61 to S64.

In S61, an initial model is determined.

Specifically, the initial model 50 at least includes a to-be-trained feature extraction network 501 (corresponding to a backbone network (Backbone) in FIG. 5), a to-be-trained feature fusion network 502 (corresponding to a neck network (Neck) in FIG. 5), a to-be-trained feature prediction network 503 (corresponding to a drivable area segmentation head (Freespace_head) in FIG. 5), and a to-be-trained auxiliary network 504 (corresponding to an auxiliary head (Auxiliary_head) in FIG. 5). The auxiliary network 504 determines an auxiliary boundary feature based on output data of the plurality of feature fusion operations in the feature fusion network 502.

The Backbone's primary function is to extract useful feature information from the input image and the target image area, and pass the feature information to subsequent network layers. The Neck's primary function is to perform multi-scale feature fusion based on the feature information extracted by the Backbone. The Neck may employ an architecture of Feature Pyramid Network (FPN) which constructs a feature pyramid to effectively fuse multi-scale features and obtain the fusion feature.

Further, the auxiliary network 504 may include a plurality of first convolutional networks (corresponding to CNN₁ in FIG. 5), a plurality of second convolutional networks (corresponding to CNN₂ in FIG. 5), and a third convolutional network (corresponding to CNN₃ in FIG. 5). The plurality of CNN₁ are in one-to-one correspondence to the output data of the plurality of feature fusion operations, and also in one-to-one correspondence to the plurality of CNN₂. Each CNN₁ is configured to perform convolution processing on the corresponding output data. Afterward, the convolution-processed data is upsampled and input into the corresponding CNN₂ for convolution processing. Afterward, feature slicing is performed on the output data of CNN₂ to obtain a preliminary auxiliary boundary feature. The preliminary auxiliary boundary feature is then input into CNN₃ for convolution processing to obtain the auxiliary boundary feature.

Further, the feature prediction network 503 may include a fourth convolutional network (corresponding to CNN4 in FIG. 5) and a fifth convolutional network (corresponding to CNN5 in FIG. 5). CNN4 is used to decode a splicing feature obtained by splicing the target image feature and the fusion feature to obtain a preliminary boundary feature of the drivable area. CNN5 is used to perform convolution processing on the preliminary boundary feature of the drivable area to obtain the boundary feature of the drivable area.

A convolutional neural network structure adopted by CNN1 to CNN5 may be the same or different, and can be specifically configured in combination with an actual application scenario, which is not limited in the embodiments of the present disclosure.

It should be noted that, in specific implementation, the auxiliary network 504 may be used only during model training (but not during inference), assisting in optimizing parameters of each network in the initial model 50 during training. Compared with existing segmentation model inference schemes that use a complex network structure similar to the auxiliary network 504 to predict a boundary feature of the drivable area, the embodiments utilize a more lightweight and streamlined feature prediction network 503 to predict the boundary feature of the drivable area during model inference, while utilizing the complex auxiliary network 504 only during model training to optimize model parameters. This effectively reduces computational resources and time overhead of model inference while obtaining sufficiently optimized network parameters.

In S62, sample images are input into the initial model for initial training based on a preset first target loss function to obtain an optimized feature extraction network, an optimized feature fusion network, an optimized feature prediction network, and an optimized auxiliary network.

In S63, parameters of the optimized feature extraction network and the optimized feature fusion network are fixed, and the sample images are input into the initial model for retraining based on a preset second target loss function to obtain a fine-tuned feature prediction network and a fine-tuned auxiliary network.

In S64, the pre-trained model is constructed by using the optimized feature extraction network, the optimized feature fusion network, and the fine-tuned feature prediction network.

Further, the first target loss function L1 and the second target loss function L2 are obtained by performing a weighted operation based on at least a first sub-loss function L₁₁ and a second sub-loss function L₁₂. During a training process, a function value of the first sub-loss function L₁₁ is determined based on a difference between a plurality of predicted boundary points and a plurality of labeled boundary points, and a function value of the second sub-loss function L₁₂ is determined based on a difference between a plurality of auxiliary predicted boundary points and the plurality of labeled boundary points.

The plurality of predicted boundary points are obtained by performing post-processing on a sample boundary feature output by the feature prediction network 503, the plurality of auxiliary predicted boundary points are obtained by performing post-processing on the auxiliary boundary feature output by the fine-tuned auxiliary network 504, and the plurality of labeled boundary points are boundary points of the drivable area labeled on the sample images (for example, the drivable area is labeled in the sample images, and a contour or a boundary line of the labeled drivable area is sampled to obtain the plurality of labeled boundary points).

In practice, polygonal annotation may be used to label the drivable area. During training, the labeled drivable area may be converted into a corresponding masked area for training. Sample images can be labeled with two categories including “background” and “drivable area”. Various obstacles and construction areas fall into the “background” category.

In a specific implementation, the first sub-loss function L₁₁ and the second sub-loss function L₁₂ may be existing loss functions, including but not limited to: L1 loss function, L2 loss function, cross entropy loss function, mean square error loss function, etc.

Further, a weight of the first sub-loss function L₁₁ is greater than a weight of the second sub-loss function L₁₂. As a non-limiting embodiment, the weight of the first sub-loss function L₁₁ may be set to 1.0, and the weight of the second sub-loss function L₁₂ may be set to 0.5.

In the embodiments of the present disclosure, the feature prediction network 503 and the auxiliary network 504 in the initial model 50 are used to construct the pre-trained model and play a key role in influencing accuracy of obtaining the boundary points of the drivable area. Therefore, the pre-trained model with higher prediction accuracy can be obtained by optimizing and fine-tuning parameters of the feature prediction network 503 and the auxiliary network 504 via two-round training. Further, compared with the auxiliary network 504, the feature prediction network 503 has a higher importance level. Accordingly, setting a larger weight for the first sub-loss function during the training process helps to achieve better training results.

Further, the initial model 50 may be a multi-task model. In a specific implementation, the initial model 50 and the pre-trained model for inference may further include other appropriate task heads, such as a target detection task head (corresponding to detect_module_head in FIG. 5), a lane detection task head (corresponding to lane_module_head in FIG. 5), and a depth estimation task head (corresponding to depth_module_head in FIG. 5).

Specifically, the target detection task head performs target detection (including but not limited to: detection of vehicles, pedestrians, traffic signs, buildings, etc.) based on the fusion feature output by the feature fusion network 502, and outputs target detection feature data. The target detection feature data is post-processed to obtain a target detection result. The lane line detection task head performs lane line detection based on the fusion feature output by the feature fusion network 502, and outputs lane line detection feature data. The lane line detection feature data is post-processed to obtain a lane line detection result. The depth estimation task head performs depth estimation based on the fusion feature output by the feature fusion network 502, and outputs depth feature data of a target. The depth feature data is post-processed to obtain depth data of the target (i.e., a distance between the target and the camera).

In a case that the initial model 50 also includes the aforementioned task head networks, corresponding training data may be designed for each task head network during the training of the initial model 50. For example, for the object detection task head, rectangles may be used for labeling in the corresponding sample images; for the lane detection task head, a mixed labeling method of polygons, lines and points may be used in the corresponding sample images; and for the depth estimation task head, rectangles and points may be used for labeling in the corresponding sample images.

Further, during the initial training process, the first target loss function L1 may be obtained by performing a weighted operation on the first sub-loss function L₁₁, the second sub-loss function L₁₂, the third sub-loss function L₁₃, the fourth sub-loss function L₁₄, and the fifth sub-loss function L₁₅. A function value of the third sub-loss function L₁₃ is determined based on a difference between a target detection result obtained by the target detection task head and a target labeled in the sample images, a function value of the fourth sub-loss function L₁₄ is determined based on a difference between a lane line detection result obtained by the lane line detection task head and a lane line labeled in the sample images, and a function value of the fifth sub-loss function L₁₅ is determined based on a difference between depth data of the target obtained by the depth estimation task head and depth of the target labeled in the sample images.

Further, after data such as the target drivable area, the target detection result, the lane line detection result, and the target depth value are obtained, the data is fused to obtain a complete multi-task detection result which is provided to subsequent autonomous driving decision nodes (e.g., route planning nodes).

Regarding a specific implementation scheme for post-processing the feature data output by each task head network, reference may be made to the aforementioned scheme for post-processing the boundary feature of the drivable area output by feature prediction network 503 (i.e., the image-based post-processing scheme), which is not repeated here. Further, a specific network structure of each task head may be implemented using an existing similar task network structure, which is not limited in the embodiments of the present disclosure.

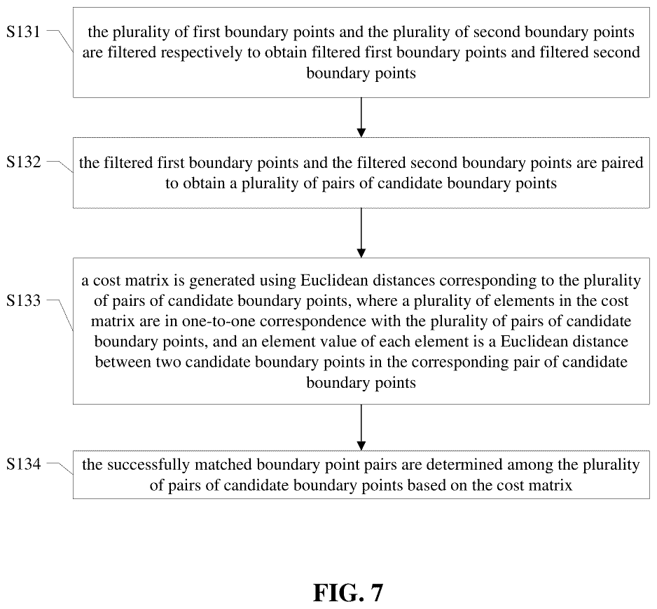

Referring to FIG. 7, FIG. 7 is a flow chart of a specific implementation of S13 in FIG. 1. In this implementation, S13 may specifically include S131 to S134.

In S131, the plurality of first boundary points and the plurality of second boundary points are filtered respectively to obtain filtered first boundary points and filtered second boundary points.

Further, the filtered first boundary point may be the first boundary points located in the target image area among the plurality of first boundary points. The filtered second boundary points may be the boundary points remaining after removing target boundary points from the plurality of second boundary points, where the target boundary points are points on a first edge of the drivable area formed by the plurality of second boundary points. The first edge may be a lower edge of the drivable area.

In an embodiment of the present disclosure, after the plurality of first boundary points and the plurality of second boundary points are obtained, a portion of invalid boundary points are removed by filtering, thereby effectively reducing the amount of data, decreasing the number of rows and columns of the cost matrix obtained subsequently, lowering overhead, and improving matching efficiency.

In S132, the filtered first boundary points and the filtered second boundary points are paired to obtain a plurality of pairs of candidate boundary points.

In S133, a cost matrix is generated using Euclidean distances corresponding to the plurality of pairs of candidate boundary points, where a plurality of elements in the cost matrix are in one-to-one correspondence with the plurality of pairs of candidate boundary points, and an element value of each element is a Euclidean distance between two candidate boundary points in the corresponding pair of candidate boundary points.

In S134, the successfully matched boundary point pairs are determined among the plurality of pairs of candidate boundary points based on the cost matrix.

Further, the cost matrix is a two-dimensional matrix including M rows of elements, where M is a positive integer. S134 may include: for each row of the cost matrix, subtracting a minimum element of the row from each element of the row, and for each column of the cost matrix, subtracting a minimum element of the column from each element of the column, thereby obtaining a preliminary update matrix; performing one or more rounds of iterative operations based on the preliminary update matrix to obtain a target cost matrix, where in each round of iteration, a minimum number of horizontal lines and vertical lines are used to cover all elements whose element values in the update matrix of the current round are a first value, and if a sum of the number of the horizontal lines and the vertical lines is less than M, a minimum first element is subtracted from each first element in the update matrix of the current round that is not covered by the horizontal lines or the vertical lines, and the minimum first element is added to each second element that is covered by both the horizontal lines and the vertical lines to obtain the update matrix of a next round, a next round of iteration is continued until the sum of the number of the horizontal lines and the vertical lines is equal to M, and the update matrix of the last round is used as the target cost matrix, where the update matrix of the first round is the preliminary update matrix; and taking the candidate boundary point pairs corresponding to the elements with the first value in the target cost matrix as the successfully matched boundary point pairs.

In a non-limiting embodiment, the first value may be set to 0, that is, each candidate boundary point pair with a Euclidean distance of 0 is regarded as the successfully matched boundary point pair.

From above, the cost matrix is obtained by using the Euclidean distance, and an iterative matching algorithm is used to help find an optimal matching point of each first boundary point in the second boundary point, thereby improving the accuracy of the target drivable area determined subsequently.

Still referring to FIG. 1, in a specific implementation of S14, the successfully matched first boundary points among the plurality of first boundary points are replaced with matched second boundary points, and an area formed by the replaced first boundary points and at least a portion of the unsuccessfully matched first boundary points serves as the target drivable area.

At least the portion of the unsuccessfully matched first boundary points may specifically be the first boundary points that are not successfully matched among the filtered first boundary points.

As mentioned above, the pixel-level boundary of the drivable area obtained by segmentation, especially that farther from the camera in the image, is smaller in size. Therefore, the feature extraction may result in missed or incorrect boundary detection, thereby causing a blurring problem at the boundary of the drivable area. In the embodiments of the present disclosure, as the target image area is a portion of the input image and has a smaller original size than that of the input image, when both original sizes are scaled to meet a same input size, the size of the boundary of the drivable area in the target image area, particularly a size of the boundary of the drivable area located farther from the camera in the image, is larger than the size of the boundary of the drivable area in the input image. After feature extraction at the same scale (i.e., sampling at the same downsampling rate) is performed, the target image area can provide richer boundary feature information than the input image. In other words, the positions of the plurality of second boundary points are more accurate than those of the plurality of first boundary points.

Further, by matching the plurality of first boundary points with the plurality of second boundary points, the second boundary point that best matches each first boundary point is found; the successfully matched second boundary point is then used to replace the matched first boundary point; and finally, the target drivable area is obtained based on the replaced first boundary point. Compared with using the area formed by the plurality of first boundary points as the target drivable area, the embodiments may effectively improve the definition and accuracy of the obtained target drivable area, more particularly mitigating a blurring problem at the boundary of the drivable area located farther from the camera.

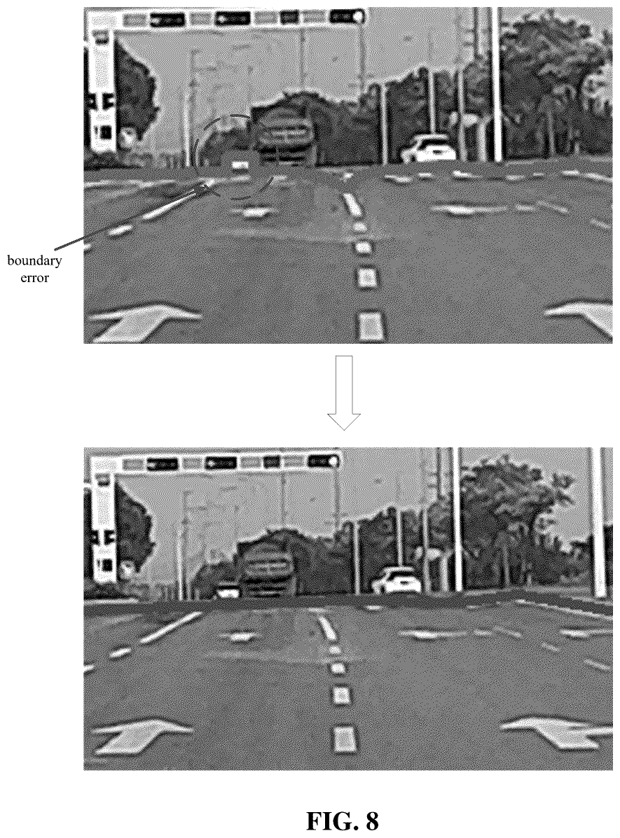

Referring to FIG. 8, FIG. 8 is a comparison diagram of effects of a target drivable area obtained by directly performing drivable area segmentation on an input image and a target drivable area obtained by using a solution in an embodiment of the present disclosure. Both images in FIG. 8 are magnified several times to present the effects.

Specifically, a blue boundary line shown in an upper part of FIG. 8 is a portion of a contour of the target drivable area formed by the plurality of first boundary points obtained by directly performing drivable area segmentation on the input image, and a red boundary line shown in a lower part of FIG. 8 is a portion of a contour of the target drivable area obtained by using the solution provided in the embodiments of the present disclosure. That is, the lower part of FIG. 8 illustrates the target drivable area obtained by fusing the plurality of second boundary points obtained by performing drivable area segmentation on the target image area.

By comparison, it can be seen that the contour of the drivable area in the upper part of FIG. 8 has a boundary error at a position of a vehicle on a left side of a distant truck (such as an area circled by a red dotted circle in FIG. 8), which is relatively blurred and less smooth. The contour of the drivable area in the lower part of FIG. 8 does not have the aforementioned error at the position of the vehicle on the left side of the distant truck, and definition and smoothness of the boundary are improved.

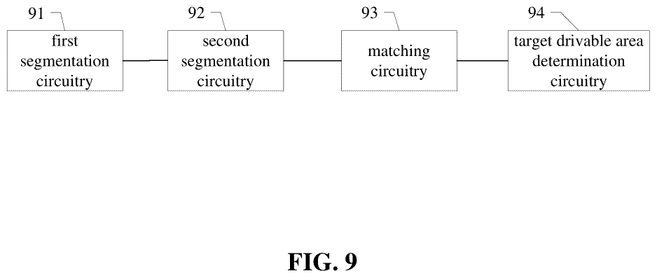

Referring to FIG. 9, FIG. 9 is a schematic structural diagram of an apparatus for determining a drivable area according to an embodiment of the present disclosure. The apparatus includes: a first segmentation circuitry 91, a second segmentation circuitry 92, a matching circuitry 93 and a target drivable area determination circuitry 94.

The first segmentation circuitry 91 is configured to perform drivable area segmentation on an input image to obtain a plurality of first boundary points.

The second segmentation circuitry 92 is configured to perform drivable area segmentation on a target image area to obtain a plurality of second boundary points, where the target image area is a portion of the input image.

The matching circuitry 93 is configured to match the plurality of first boundary points with the plurality of second boundary points to obtain successfully matched boundary point pairs.

The target drivable area determination circuitry 94 is configured to: replace the successfully matched first boundary points among the plurality of first boundary points with matched second boundary points, and take an area formed by the replaced first boundary points and at least a portion of the unsuccessfully matched first boundary points as a target drivable area.

More details of principles, specific implementation and advantages of the apparatus can be referred to related descriptions of the above method shown in FIG. 1 to FIG. 8, and are not repeated here.

In an embodiment of the present disclosure, a storage medium, such as a computer-readable storage medium, is provided. The computer-readable storage medium has a computer program stored therein is provided, where when the computer program is executed by a processor, the above method shown in FIG. 1 to FIG. 8 is performed. In some embodiments, the computer-readable storage medium may include a non-volatile or a non-transitory memory, or may include an optical disc, a hard disk drive or a solid state drive.

In the embodiments of the present disclosure, the processor may be a Central Processing Unit (CPU), or other general processors, Digital Signal Processors (DSPs), Application Specific Integrated Circuits (ASICs), Field Programmable Gate Arrays (FPGAs) or other Programmable logic devices, discrete gates or transistor logic devices, discrete hardware components, and the like. A general processor may be a microprocessor or the processor may be any conventional processor or the like.

It should also be understood that the memory in the embodiments of the present disclosure may be either volatile memory or nonvolatile memory, or may include both volatile and nonvolatile memories. The non-volatile memory may be a Read-Only Memory (ROM), a Programmable ROM (PROM), an Erasable PROM (EPROM), an electrically Erasable EPROM (EEPROM), or a flash memory. The volatile memory may be a Random Access Memory (RAM) which functions as an external cache. By way of example but not limitation, various forms of RAM are available, such as Static Random Access Memory (SRAM), Dynamic Random Access Memory (DRAM), Synchronous Dynamic Random Access Memory (SDRAM), Double Data Rate Synchronous Dynamic Random Access Memory (DDR SDRAM), Enhanced SDRAM (ESDRAM), Synchronous connection to DRAM (SLDRAM), and Direct Rambus RAM (DR-RAM).

In an embodiment of the present disclosure, a terminal including a memory and a processor is provided, where the memory stores a computer program that can be run on the processor, and the processor performs the above method shown in FIG. 1 to FIG. 8 when running the computer program.

It should be understood that the term “and/or” in the present disclosure is merely an association relationship describing associated objects, indicating that there can be three types of relationships, for example, A and/or B can represent “A exists only, both A and B exist, B exists only. In addition, the character “/” in the present disclosure represents that the former and latter associated objects have an “or” relationship.

The “plurality” in the embodiments of the present disclosure refers to two or more.

The descriptions of the first, second, etc. in the embodiments of the present disclosure are merely for illustrating and differentiating the objects, and do not represent the order or the particular limitation of the number of devices in the embodiments of the present disclosure, which do not constitute any limitation to the embodiments of the present disclosure.

It should be noted that sequence numbers of steps in the embodiments do not represent a limitation on an execution order of the steps.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

What is claimed is:

1. A method for determining a drivable area, comprising:
performing drivable area segmentation on an input image to obtain a plurality of first boundary points;
performing drivable area segmentation on a target image area to obtain a plurality of second boundary points, wherein the target image area is a portion of the input image;
matching the plurality of first boundary points with the plurality of second boundary points to obtain successfully matched boundary point pairs; and
replacing the successfully matched first boundary points among the plurality of first boundary points with matched second boundary points, and taking an area formed by the replaced first boundary points and at least a portion of the unsuccessfully matched first boundary points as a target drivable area.

2. The method according to claim 1, wherein the target image area is a preset area around a center point of the input image, or a preset area around a vanishing point of the drivable area in the input image.

3. The method according to claim 1, wherein said matching the plurality of first boundary points with the plurality of second boundary points to obtain the successfully matched boundary point pairs comprises:
filtering the plurality of first boundary points and the plurality of second boundary points respectively to obtain filtered first boundary points and filtered second boundary points;
pairing the filtered first boundary points and the filtered second boundary points to obtain a plurality of pairs of candidate boundary points;
generating a cost matrix using Euclidean distances corresponding to the plurality of pairs of candidate boundary points, wherein a plurality of elements in the cost matrix are in one-to-one correspondence with the plurality of pairs of candidate boundary points, and an element value of each element is a Euclidean distance between two candidate boundary points in the corresponding pair of candidate boundary points; and
determining the successfully matched boundary point pairs among the plurality of pairs of candidate boundary points based on the cost matrix.

4. The method according to claim 3, wherein one or more of the following are met:
the filtered first boundary points being first boundary points located in the target image area among the plurality of first boundary points; or
the filtered second boundary points being boundary points remaining after removing target boundary points from the plurality of second boundary points, wherein the target boundary points are points on a first edge of the drivable area formed by the plurality of second boundary points.

5. The method according to claim 4, wherein the cost matrix is a two-dimensional matrix including M rows of elements, wherein M is a positive integer;
said determining the successfully matched boundary point pairs among the plurality of pairs of candidate boundary points based on the cost matrix comprises:
for each row of the cost matrix, subtracting a minimum element of the row from each element of the row, and for each column of the cost matrix, subtracting a minimum element of the column from each element of the column, thereby obtaining a preliminary update matrix;
performing one or more rounds of iterative operations based on the preliminary update matrix to obtain a target cost matrix, wherein in each round of iteration, a minimum number of horizontal lines and vertical lines are used to cover all elements whose element values in the update matrix of the current round are a first value, and if a sum of the number of the horizontal lines and the vertical lines is less than M, a minimum first element is subtracted from each first element in the update matrix of the current round that is not covered by the horizontal lines or the vertical lines, and the minimum first element is added to each second element that is covered by both the horizontal lines and the vertical lines to obtain the update matrix of a next round, a next round of iteration is continued until the sum of the number of the horizontal lines and the vertical lines is equal to M, and the update matrix of the last round is used as the target cost matrix, wherein the update matrix of the first round is the preliminary update matrix; and
taking the candidate boundary point pairs corresponding to the elements with the first value in the target cost matrix as the successfully matched boundary point pairs.

6. The method according to claim 3, wherein the cost matrix is a two-dimensional matrix comprising M rows of elements, wherein M is a positive integer;
said determining the successfully matched boundary point pairs among the plurality of pairs of candidate boundary points based on the cost matrix comprises:
for each row of the cost matrix, subtracting a minimum element of the row from each element of the row, and for each column of the cost matrix, subtracting a minimum element of the column from each element of the column, thereby obtaining a preliminary update matrix;
performing one or more rounds of iterative operations based on the preliminary update matrix to obtain a target cost matrix, wherein in each round of iteration, a minimum number of horizontal lines and vertical lines are used to cover all elements whose element values in the update matrix of the current round are a first value, and if a sum of the number of the horizontal lines and the vertical lines is less than M, a minimum first element is subtracted from each first element in the update matrix of the current round that is not covered by the horizontal lines or the vertical lines, and the minimum first element is added to each second element that is covered by both the horizontal lines and the vertical lines to obtain the update matrix of a next round, a next round of iteration is continued until the sum of the number of the horizontal lines and the vertical lines is equal to M, and the update matrix of the last round is used as the target cost matrix, wherein the update matrix of the first round is the preliminary update matrix; and
taking the candidate boundary point pairs corresponding to the elements with the first value in the target cost matrix as the successfully matched boundary point pairs.

7. The method according to claim 1, wherein the drivable area segmentation on the input image comprises boundary feature acquisition and post-processing;
wherein a boundary feature of the drivable area is determined via the boundary feature acquisition based on the input image; and
the post-processing comprises:
performing pixel value conversion on the boundary feature of the drivable area to obtain a converted image;
performing contour extraction on the converted image to obtain a plurality of candidate connected areas;
taking boundary points of the candidate connected area with a largest area among the plurality of candidate connected areas as preliminary boundary points; and
performing linear transformation on coordinates of the preliminary boundary points to obtain the plurality of first boundary points.

8. The method according to claim 7, wherein said performing contour extraction on the converted image to obtain the plurality of candidate connected areas comprises:
performing binarization processing on the converted image to obtain a grayscale image;
performing an opening operation on the grayscale image to obtain a denoised image; and
performing contour extraction on the denoised image to obtain the plurality of candidate connected areas.

9. The method according to claim 7, wherein the boundary feature acquisition comprises:
performing a plurality of feature extraction operations at different scales on the input image to obtain a plurality of image features, wherein input data of the first feature extraction operation is the input image, and from the second feature extraction operation, input data of the current feature extraction operation is output data of a previous feature extraction operation;
performing a plurality of feature fusion operations at different scales based on the plurality of image features to obtain a fusion feature, wherein the plurality of feature extraction operations are in one-to-one correspondence with the plurality of feature fusion operations, input data of the first feature fusion operation is image features output by the last feature extraction operation, and from the second feature fusion operation, input data of the current feature fusion operation comprises output data of the corresponding feature extraction operation and output data of a previous feature fusion operation; and
selecting a target image feature from the plurality of image features, performing feature splicing on the target image feature and the fusion feature to obtain a splicing feature, and decoding the splicing feature to obtain the boundary feature of the drivable area.

10. The method according to claim 9, wherein the boundary feature acquisition performed on the input image is implemented using a pre-trained model which comprises a feature extraction network, a feature fusion network, and a feature prediction network;
wherein the feature extraction network performs the plurality of feature extraction operations at different scales on the input image to obtain the plurality of image features;
the feature fusion network performs the plurality of feature fusion operations at different scales based on the plurality of image features to obtain the fusion feature; and
the feature prediction network performs the feature splicing on the target image feature and the fusion feature among the plurality of image features to obtain the splicing feature, and decodes the splicing feature to obtain the boundary feature of the drivable area.

11. The method according to claim 10, wherein the pre-trained model is trained in a following manner:
determining an initial model, wherein the initial model comprises a to-be-trained feature extraction network, a to-be-trained feature fusion network, a to-be-trained feature prediction network, and a to-be-trained auxiliary network;
inputting sample images into the initial model for initial training based on a preset first target loss function to obtain an optimized feature extraction network, an optimized feature fusion network, an optimized feature prediction network, and an optimized auxiliary network;
fixing parameters of the optimized feature extraction network and the optimized feature fusion network, and inputting the sample images into the initial model for retraining based on a preset second target loss function to obtain a fine-tuned feature prediction network and a fine-tuned auxiliary network; and
constructing the pre-trained model by using the optimized feature extraction network, the optimized feature fusion network, and the fine-tuned feature prediction network;
wherein an auxiliary boundary feature is determined by the fine-tuned auxiliary network based on output data of the plurality of feature fusion operations in the feature fusion network.

12. The method according to claim 11, wherein the first target loss function and the second target loss function are obtained by performing a weighted operation based on at least a first sub-loss function and a second sub-loss function; and
during a training process, a function value of the first sub-loss function is determined based on a difference between a plurality of predicted boundary points and a plurality of labeled boundary points, and a function value of the second sub-loss function is determined based on a difference between a plurality of auxiliary predicted boundary points and the plurality of labeled boundary points;
wherein the plurality of predicted boundary points are obtained by performing post-processing on a sample boundary feature output by the feature prediction network, the plurality of auxiliary predicted boundary points are obtained by performing post-processing on the auxiliary boundary feature output by the fine-tuned auxiliary network, and the plurality of labeled boundary points are boundary points of the drivable area labeled on the sample images.

13. The method according to claim 12, wherein a weight of the first sub-loss function is greater than a weight of the second sub-loss function.

14. A non-transitory storage medium storing one or more programs, the one or more programs comprising computer instructions, which, when executed by a processor, cause the processor to:
perform drivable area segmentation on an input image to obtain a plurality of first boundary points;
perform drivable area segmentation on a target image area to obtain a plurality of second boundary points, wherein the target image area is a portion of the input image;
match the plurality of first boundary points with the plurality of second boundary points to obtain successfully matched boundary point pairs; and
replace the successfully matched first boundary points among the plurality of first boundary points with matched second boundary points, and take an area formed by the replaced first boundary points and at least a portion of the unsuccessfully matched first boundary points as a target drivable area.

15. A terminal comprising a memory and a processor, wherein the memory stores one or more programs, the one or more programs comprising computer instructions, which, when executed by the processor, cause the processor to:
perform drivable area segmentation on an input image to obtain a plurality of first boundary points;
perform drivable area segmentation on a target image area to obtain a plurality of second boundary points, wherein the target image area is a portion of the input image;
match the plurality of first boundary points with the plurality of second boundary points to obtain successfully matched boundary point pairs; and
replace the successfully matched first boundary points among the plurality of first boundary points with matched second boundary points, and take an area formed by the replaced first boundary points and at least a portion of the unsuccessfully matched first boundary points as a target drivable area.

16. The terminal according to claim 15, wherein the target image area is a preset area around a center point of the input image, or a preset area around a vanishing point of the drivable area in the input image.

17. The terminal according to claim 15, wherein the processor is further caused to:
filter the plurality of first boundary points and the plurality of second boundary points respectively to obtain filtered first boundary points and filtered second boundary points;
pair the filtered first boundary points and the filtered second boundary points to obtain a plurality of pairs of candidate boundary points;
generate a cost matrix using Euclidean distances corresponding to the plurality of pairs of candidate boundary points, wherein a plurality of elements in the cost matrix are in one-to-one correspondence with the plurality of pairs of candidate boundary points, and an element value of each element is a Euclidean distance between two candidate boundary points in the corresponding pair of candidate boundary points; and
determine the successfully matched boundary point pairs among the plurality of pairs of candidate boundary points based on the cost matrix.

18. The terminal according to claim 17, wherein one or more of the following are met:
the filtered first boundary points being first boundary points located in the target image area among the plurality of first boundary points; or
the filtered second boundary points being boundary points remaining after removing target boundary points from the plurality of second boundary points, wherein the target boundary points are points on a first edge of the drivable area formed by the plurality of second boundary points.

19. The terminal according to claim 15, wherein the drivable area segmentation on the input image comprises boundary feature acquisition and post-processing;
wherein a boundary feature of the drivable area is determined via the boundary feature acquisition based on the input image; and
the post-processing comprises:
performing pixel value conversion on the boundary feature of the drivable area to obtain a converted image;
performing contour extraction on the converted image to obtain a plurality of candidate connected areas;
taking boundary points of the candidate connected area with a largest area among the plurality of candidate connected areas as preliminary boundary points; and
performing linear transformation on coordinates of the preliminary boundary points to obtain the plurality of first boundary points.

20. A computer program product comprising a computer program, wherein when the computer program is run by a processor, a method is performed, the method comprising:
performing drivable area segmentation on an input image to obtain a plurality of first boundary points;
performing drivable area segmentation on a target image area to obtain a plurality of second boundary points, wherein the target image area is a portion of the input image;
matching the plurality of first boundary points with the plurality of second boundary points to obtain successfully matched boundary point pairs; and
replacing the successfully matched first boundary points among the plurality of first boundary points with matched second boundary points, and taking an area formed by the replaced first boundary points and at least a portion of the unsuccessfully matched first boundary points as a target drivable area.
